(19) United States
(12) Patent Application Publication
(10) Pub. No.: US 2008/0177843 A1
(43) Pub. Date: Jul. 24, 2008

(54) INFERRING EMAIL ACTION BASED ON USER INPUT

(75) Inventors: Eliot C. Gillum, Mountain View, CA (US); Pablo M. Stern, San Francisco, CA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 11/625,819

(22) Filed: Jan. 22, 2007

(51) Int. Cl. G06F 15/16

(52) U.S. Cl. 709/206

(57) ABSTRACT

A computer implemented computer method for assisting email users. When a user selects an action with respect to email source such as an email address, the user's intended action is inferred. The source validity is checked. Where a user provides input identifying an email as spam, the inferred action may be to add the email address associated with the message to a user block list. The address may be added only where the address or domain are identified as valid sources of email.

### BACKGROUND

The most common use of the Internet is communication via electronic mail. Common forms of web-based email services are provided by Email Service Providers (ESPs) examples of which include Yahoo! Mail, Microsoft Live Mail, Google GMail, and others. Each of these providers receives a large number of messages which are inbound to the providers, many of which are phishing messages, spam messages or unsolicited bulk-email messages. These provides also receive a number of messages from legitimate institutions whose customers have provided their web-based email as the primary means of electronic communication.

Large scale ESPs can stop a limited amount of spam and phishing email using various spam detection mechanisms, including comparing the sending IP address to a list of known spammer addresses or confirming the validity of the sending IP address with a Domain Name Service (DNS) server. Most ESPs, as well as many email clients, allow users to add addresses and/or domains to a user-specific “block” list. Messages from email addresses or domains on the block list will not be delivered to the user's inbox, but will simply be deleted or routed to, for example, a spam folder. ESPs may also maintain a “global” or system-wide blacklist of known addressees and domains which should be blocked. This global list may be implemented as part of the ESP's spam filtering system.

Some providers allow users to “safelist” email addresses using various mechanisms. For example, bulk mail routed to a user's spam or deleted items folder may be marked as “not spam” and future messages from the “from” address identified on a safelist are then allowed to pass to the user's inbox the future.

Often, however, block listing messages is ineffective if the email or domain is fake. Spam senders often use fake addresses and domains to avoid detection. As a result, blocking fake addresses and domains reduces the benefit of marking messages to block.

### SUMMARY

The technology, roughly described comprises a computer implemented computer method for assisting email users. When a user provides input on an email source such as an email address, an action can be inferred from the input. The action may include adding the source to a user block or safe list. However, prior to adding the source to the list, the source validity is checked. The method includes receiving an action from a user which can be inferred to be a request to add an email source to a block list associated with the user. The input is used to determine whether blocking the source would be effective against exposing the user to additional email from the source. If adding the source would be effective, the source is added to the user block list.

In another embodiment, the method includes presenting at least a portion of an email message to a user for review. An action is received from a user which can be inferred to be a request to add the source to a user block list or safe list. This may include determining whether blocking the source would be effective against exposing the user to additional email from the source, and if the determination is that blocking the source would be effective, adding the email to a block list or safe list based on the user action.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIGS. 1A-1C depicts a general method in accordance with the technology discussed herein.

FIGS. 2A-2C depict various techniques for implementing a block list check in the method of FIG. 1.

FIG. 3 is an exemplary environment for implementing the technology discussed herein.

FIG. 4 is a depiction of an exemplary blocking interface.

FIG. 5 depicts an exemplary warning interface

FIG. 6 depicts a processing system suitable for use in the systems described with respect to FIGS. 3.

### DETAILED DESCRIPTION

Technology is described herein for implementing a system which recognizes input from a user with respect an email message and infers a proper action from the user input. In one case, for example, where a user provides input identifying an email as spam, the inferred action may be to add the email address associated with the message to a user block list. In this example, the address may be added only where the address or domain are identified as valid sources of email.

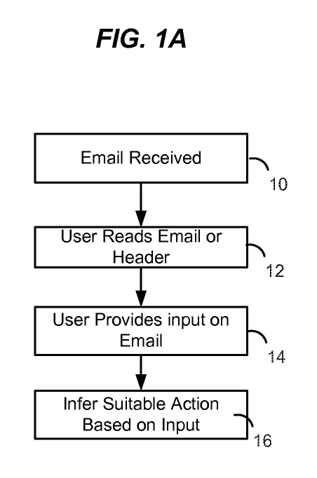

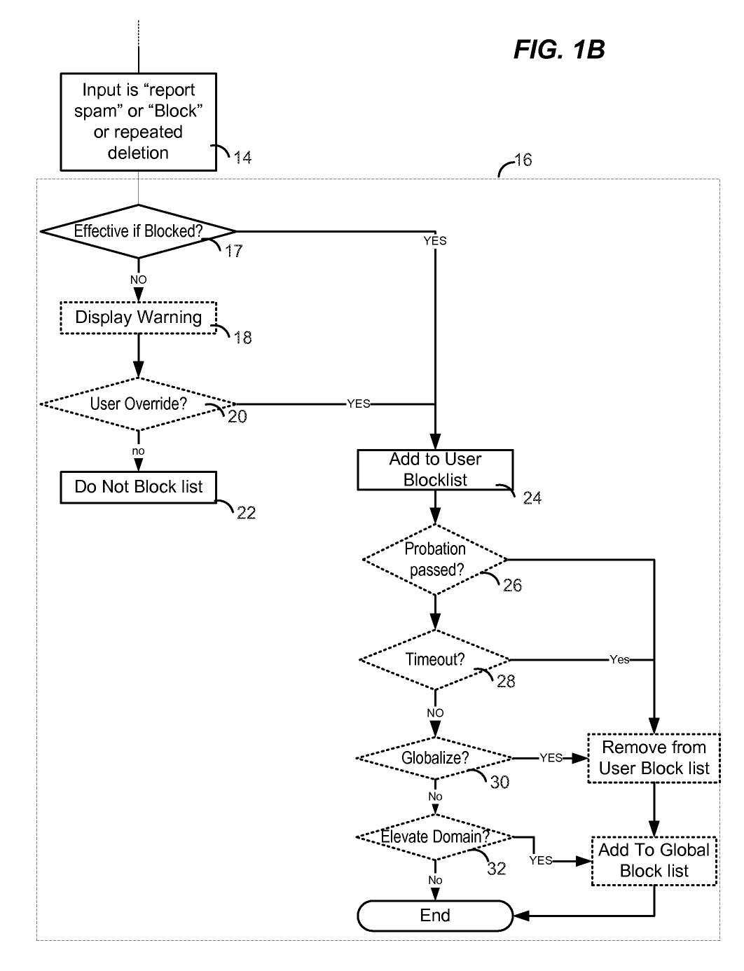

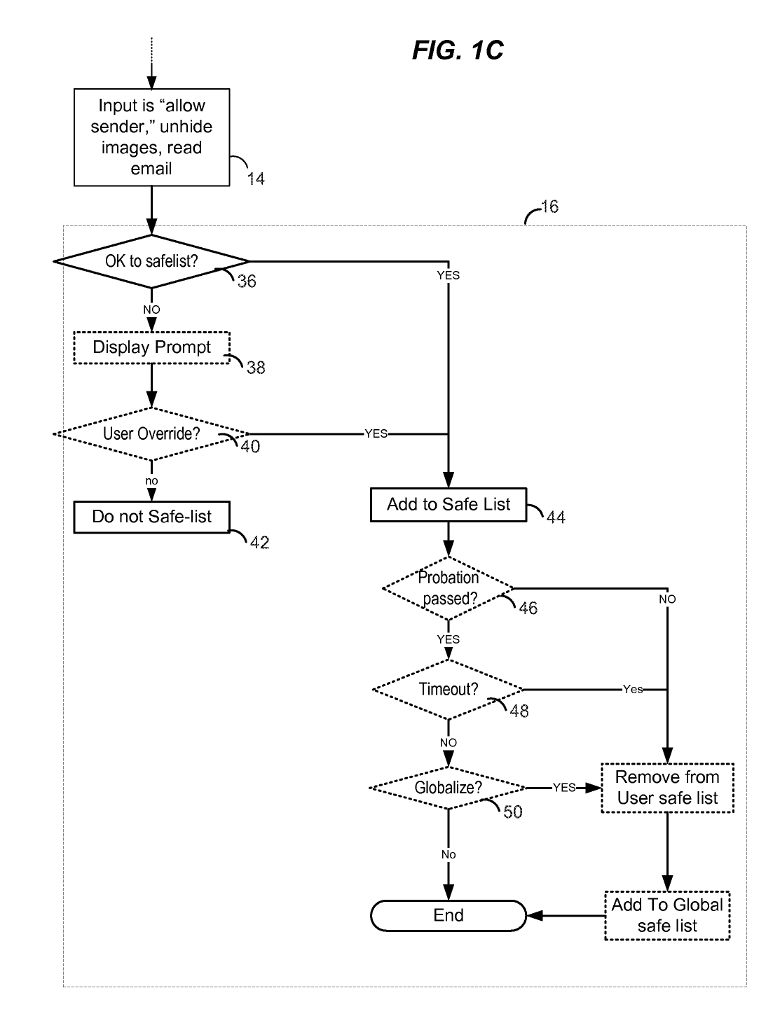

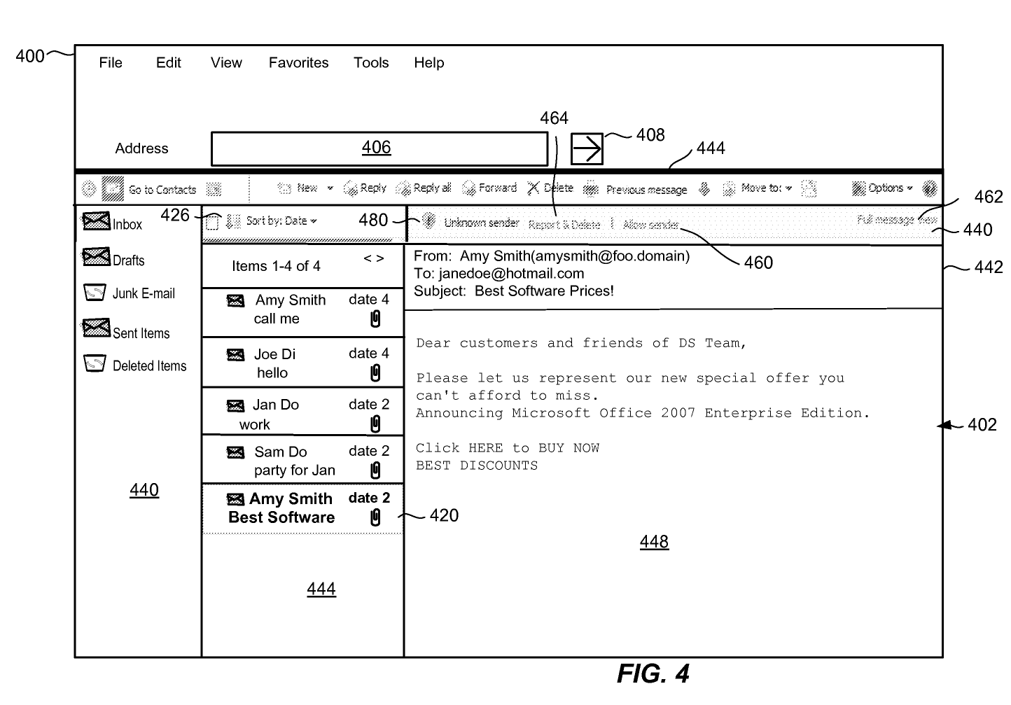

FIG. 1a-1c illustrate a method in accordance with the present invention for inferring an intended user action based on user input and the characteristics of emails received from a particular source. FIGS. 1a-1c will be described with reference to FIG. 4 which is a depiction of a user interface which may be presented by a web-based email system to a user.

Briefly, FIG. 4 shows an email user interface 402 such as that which may be available in Windows Live™ Mail in a browser window 400. The interface 402 includes an address field 406 and a go button 408, allowing a user to search mail or the internet. A menu bar 444 is also provided, allowing the user to create a new message, reply to a message, forward a message, delete a message and print a message, as well as navigate to other parts of the service provider's available services to the user. A menu pane 440 allows the user to select various folders (Inbox, Drafts, Junk E-Mail, Sent Items, Deleted Items) in the email application 402. Menu pane 444 shows a list of the emails in the user's inbox, and a selected email message 420 is indicated as being from “Amy Smith” at an email address of “amysmith@hotmail.com”. This is shown in a header field 442. A preview of the message is shown in pane 448. A warning bar 440 indicates that the service provider has determined that the email is from an unknown sender and provides a “report and delete” option 464 as well as an “allow sender” option 460. These options may infer block listing and safelisting the email address, respectively. A “full message” view option 462 is also provided. It will be recognized that a number of different warnings may be provided. In an alternative to the example shown in FIG. 4, the “subject,” “to” and “from” fields 442 need not be shown.

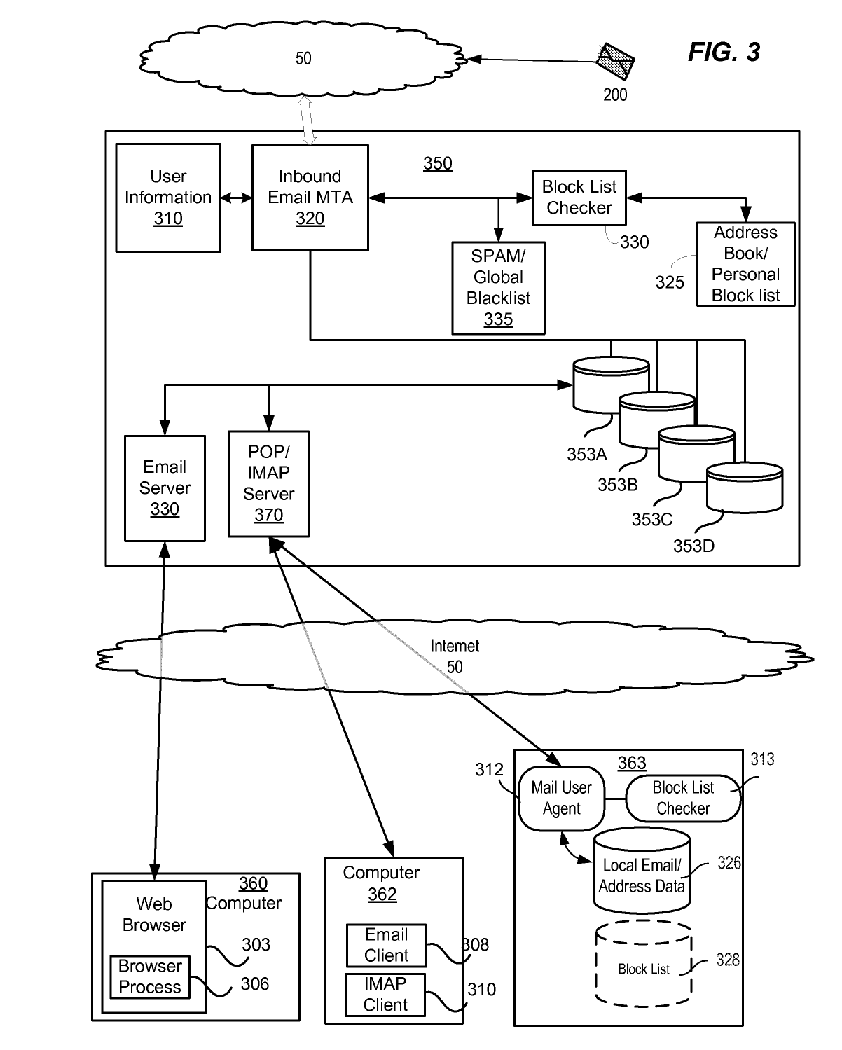

Returning to FIG. 1a, initially it is noted that steps shown in FIGS. 1A-1C in dashed lines are optional. In one embodiment, none of the optional steps need be employed; in an alternative embodiment, any one or more are employed; and in yet another embodiment, all optional steps are employed. Further, as described below with respect to FIG. 3, is should be understood that an ESP may allow users to have individual block lists. In addition, the method will be described with respect to block listing addresses, but it should be recognized that in each instance where an address is discussed as being block listed, an entire domain or sub-domain associated with that address may be block listed.

At step 10, an email is received from a particular source by a user. At step 12, the user may either read or preview the email by viewing the message or the sending user name and email header.

At step 14, the user provides input on the email which may suggest an action that the user wants to occur. The input may take many forms, such as an affirmative action to identify the email as SPAM, suggesting the user wishes to block list the source of the email. Alternatively, the user may “allow” the source, suggesting the user wishes to safe-list the source. In many cases, this may be performed by selecting a “block” button or, in the case of FIG. 4, by selecting “report and delete” 464. Note that separate “block” and “report and delete” action interfaces may be provided. The “report and delete” function may further send information to the spam filtering implementation of an ESP system.

At step 16, in a unique aspect of the technology, when a user selects to block a source or report a source as spam, a determination is made to infer the user's true intended action. In one example, the intent of the action is to add the source to a user's personal block list. Another intended action may be to add the source to the user's safe-list. FIGS. 1b and 1c show various implementations of step 16 based on whether the item should be block listed or safe listed based on the user's input.

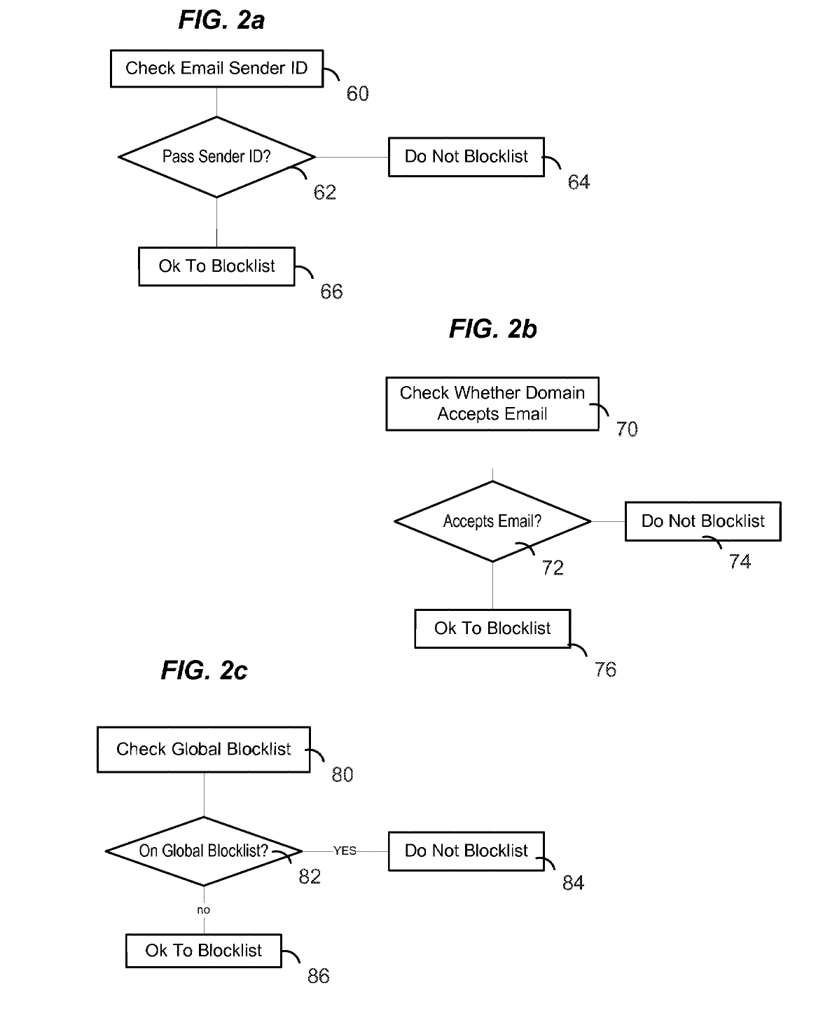

At step 14, if one of a selected type of actions is taken by the user, a test is made at step 17 to determine whether blocking the source will be effective. If the source is not a valid email address, for example, adding the source to the user block list will have no effect, and it can be inferred that the user really did not intend to add the source to their list because adding the source would not be effective in preventing additional emails from this address from reaching the user. Various methods of determining whether to block list an address are shown in FIGS. 2A through 2C, discussed below. Each of the methods determines whether the block listing is likely to result in an effective block. If the method determines that the address should not be blocked because blocking the address would not be effective, the item is not added to any block at step 22. Note that the “block” function may be transparent to the users. Simply clicking on “report and delete” may add or a block list and report spam simultaneously.

FIGS. 2A-2C illustrate various methods for determining whether an address should be block listed. In FIG. 2a, an initial check is made to determine whether an email passes a SenderID or DomainKeys check. SenderID allows the owner of an Internet domain to use special format of DNS TXT records to specify which machines are authorized to transmit e-mail for that domain. Receivers checking SenderID can then determine if any e-mail that claims to come from that domain passes a check against the IPs listed in the sender policy of this domains. DomainKeys adds a header that contains a digital signature of the contents of the mail message. The receiving SMTP server then uses the name of the domain from which the mail originated, and other information to decrypt the hash value in the header field and recalculate a hash value for the mail body that was received. If the two values match, this cryptographically proves that the mail did in fact originate at the purported domain. If the message passes, it is ok to add to the source to the block list at step 66; if not, it is not ok to block at step 64 and step 16 fails.

FIG. 2B illustrates another method wherein a determination is made as to whether a given domain exists or accepts email at step 70. If the domain accepts email at step 72, then it is ok to block list at step 76; if not, it should not be block listed at step 74. A simple example for determining the validity of source domains is to check whether that the forward and reverse DNS domain names of an originated message match up exactly. In this case scenario, the IP address of an incoming connection is queried in DNS to see if a domain name is associated with the IN-ADDR.ARPA entry for that address, and a subsequent lookup for the resulting domain name is also issued to verify that the target domain name is associated with the original IP address. Records of which domains accept and do not accept email may be added to a global block list.

A third technique is shown at step 80 which is to check the global block list of the ESP. If the address is already on the block list, at step 82, then it would be redundant to add the address to the local block list and block listing is refused at 84; if not, the address may be block listed at step 86. Items may be added to the global block list through various techniques discussed herein.

In various embodiments, any one, two or all three of these techniques may be used to determine whether an address is added to a user block list at step 17.

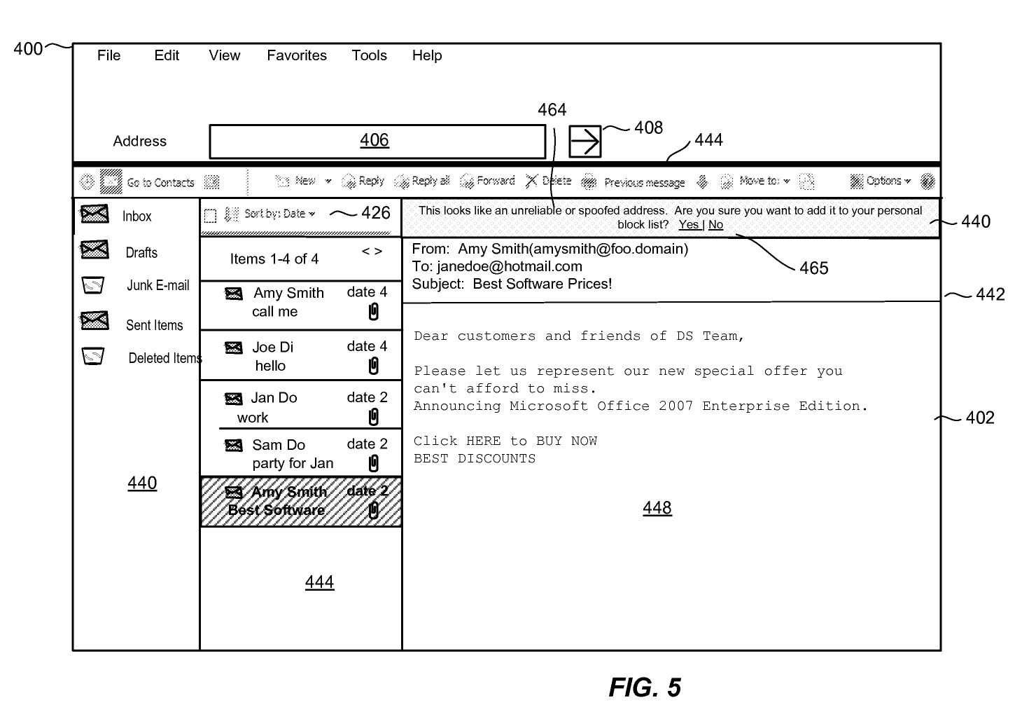

Optionally, at step 18, the user may be provided with a warning, such as that shown at 465 in FIG. 5, stating that block listing this source may not have the indented effect and allowing the user to determine whether to proceed with adding the item to the user's block list. Users may be further warned that their user block-list has a limited capacity and adding addresses of dubious effectiveness may waste block-list space. Alternatively, the use may simply be warned that the user will not receive email from this source again. At step 20, based on such information, the user may select to over ride the determination at step 16 that the item should not be blocked. FIG. 5 shows the first example of a warning 465 which may be provided. The user may be provided with a YES/NO command option to determine whether to proceed with the block listing.

If, at step 16, a determination is made that the item should be block listed, then the item may be added to the user block list at step 26.

Optionally, prior to adding the item to the user block list, a probation period may be implemented. The probation period 24 may be a system check on suspicious emails which pass some but not all of the system checks described above. During the probation period, emails from the source may still be blocked, but the source not added to the user block list until probation passed. For example, one configuration may be that all three tests set forth above with respect to step 16 are utilized and as long as one test indicates it is ok to block the source, the item will pass step 16. However, if less than two or less than three tests pass, the probation period may be implemented. Alternatively the probation period may be implemented irrespective of how the determination is made at step 16.

The probation period 24 may comprise a test to determine whether additional messages from the source which the user wished to block are received within some period of time. If, for example, no additional messages are received by the user within a 30 day period, the name will not be added to the user block list. Another alternative is to provide a two threshold test. For example, if the entry is not validated within 14 days, it is removed; however, if a low threshold number of messages is received within 14 days, it is kept and checked for 90 days before being added.

Similarly, a “time out” 28 may be provided for entries actually added to the user list. Addresses or domains added to a user block list may be removed if messages from the address or domain are not received over some period of time. Again, a two tier time-out period may be provided. The time-out is distinguished from probation in that sources are added to the user block list, whereas in the probation period, they are not.

Still further, addresses in the user block list may be globalized at step 30. In an ESP, globalization may comprise periodically scanning all or a sampling of user block lists for users in the system to look for similarities. If an address or domain appears on a number of block lists, it may be removed from user block lists and added to a system level or global block list.

Globalization may also refer to the promotion of top level domains to the block list. If the user block list scan described above results in a large number of different addresses from a common domain, that domain may be promoted to the global block list. Alternatively, IP addresses associated with that domain may be blocked.

Still further, a user list domain promotion step 32 may optionally allow the promotion of a given domain to blocked status within a user block list. If a user has a large number of addresses from a particular domain on their individual block list, the user list may be pruned of individual addresses and the domain as a whole blocked. The ESP may periodically scan the user's list and either automatically upgrade domains based on the appearance of addresses or prompt the user to indicate whether the user wishes to upgrade the block list to include the domain as well as the address. This upgrade may be a result of the absolute number of blocked addresses from a domain, a ratio of the safe-listed or otherwise positively-indicated email addresses (such as having been read) going above a threshold, or both.

In both steps 28 and 30, after globalization of the source, the address or domain is removed from the user block list and added to the global block list.

FIG. 1C shows a method similar to that shown in FIG. 1B for safe-listing a source. At step 14, the input received from which a user action was one of “allow sender”, “unhide images,” or read full email, a determination is made at step 36 as to whether safe listing the source will be effective. Step 36 may be performed by any of the methods discussed above with respect to FIGS. 2A-2C.

If the source fails checks at step 36, at step 38, the user may be provided with a warning, stating that safe listing this source may not have the indented effect and allowing the user to determine whether to proceed with adding the item to the user's safe list. At step 40, based on such information, the user may select to over ride the determination at step 16 that the item should not be blocked.

If, at step 36, a determination is made that the item should be safe listed, then the item may be added to the user block list at step 46.

As with a block list, a probation period 44 and a “time out” 48 may be provided.

Still further, addresses in the user safe list may be globalized at step 50. In an ESP, globalization may comprise periodically scanning all or a sampling of user safe lists for users in the system to look for similarities. If an address or domain appears on a number of safe lists, it may be removed from user safe lists and added to a system level or global safe list.

Mail systems suitable for implementing the methods discussed above are shown in FIG. 3. System 350 is an ESP system such as that provided by Yahoo! Mail, Microsoft Live Mail, Microsoft Exchange Server, Google Mail or other service providers.

An email service system 350 includes a number of components and services for users having accounts with the service. Mail system 350 receives messages 200 via Internet 50 to an inbound email message transfer agent (MTA) 320. The MTA acts with a user information data store 310 to deliver messages to a number of data servers 353A-353D. User information store 310 includes login information for users having accounts with the email service 350 and may direct mail to one or more of the storage servers 353A-353D. It will be recognized that each user having an account with mail system 150 may have mail stored on any or more of the storage servers 353A-353D. Mail system 350 may include a spam filter/black list server or process 335 which checks inbound messages for characteristics identifying the email as spam. In one embodiment, user information server 310, inbound email MTA 320, address book 325, storage servers 353A-353D, email server 330, and pop/IMAP server 370 are separate and distinct servers. However it should be recognized that any one of these particular servers provides services which may be combined on any combination of servers or a single server, and the particular hardware implementation of the email service 350 described in FIG. 3 is merely exemplary of the services provided by the email service 350.

Also shown is a user address book and personal information server 325, which may store user block lists in accordance with the technology provided herein. A block list checker, operable on the address book server 325 or as a stand-alone unit, interacts with the SPAM filder/Global blacklist server 335 and the user block lists 325 to implement the method discussed above.

Users operating computers 360, 362, 363 interact with system 350. The user operating device 360 may use a web browser 303 implementing a browser process to couple to a web server 330 to view email using the interface shown in FIGS. 4 and 5. A user operating computer 362 may use an POP 308 or IMAP 310 email client to interact a POP/IMAP server 370 to retrieve mail from the storage servers 353A-353D.

Computer 363 illustrates a client-based system capable of implementing the method discussed above. System 363 may interact with system 350 or with any internet service provider capable of routing mail via internet 50 to the agent 314 on computer 363. System 363 may include a mail user agent 312 capable of interacting with mail routed to the agent. System 363 further includes its own email data and address store 326, block list 328 and block list checker 313, which perform the above methods locally on system 363.

System 350 allows for features of the technology culling data from multiple users and global lists to be implemented. For example, suppose a group of individuals all have email from a user having a user address users@foo.com on their block lists. A sufficient number of entries would allow the administrator to automatically promote the address or domain to global blocked status.

In yet another alternative, multiple domain or IP group identifiers may become part of the block list.

In a further alternative, the determinations made at step 16 may be user when a user adds information to the user's safe-list, or list of accepted addresses. Email providers generally allow users to select “known good” senders. This is exemplified by the “allow sender” link in FIG. 4. The techniques shown in FIGS. 2A-2C may be used to ensure safe-list items are allowed for only known valid email senders, preventing errors on the part of users in allowing potentially nefarious email senders to continue forwarding emails to them.

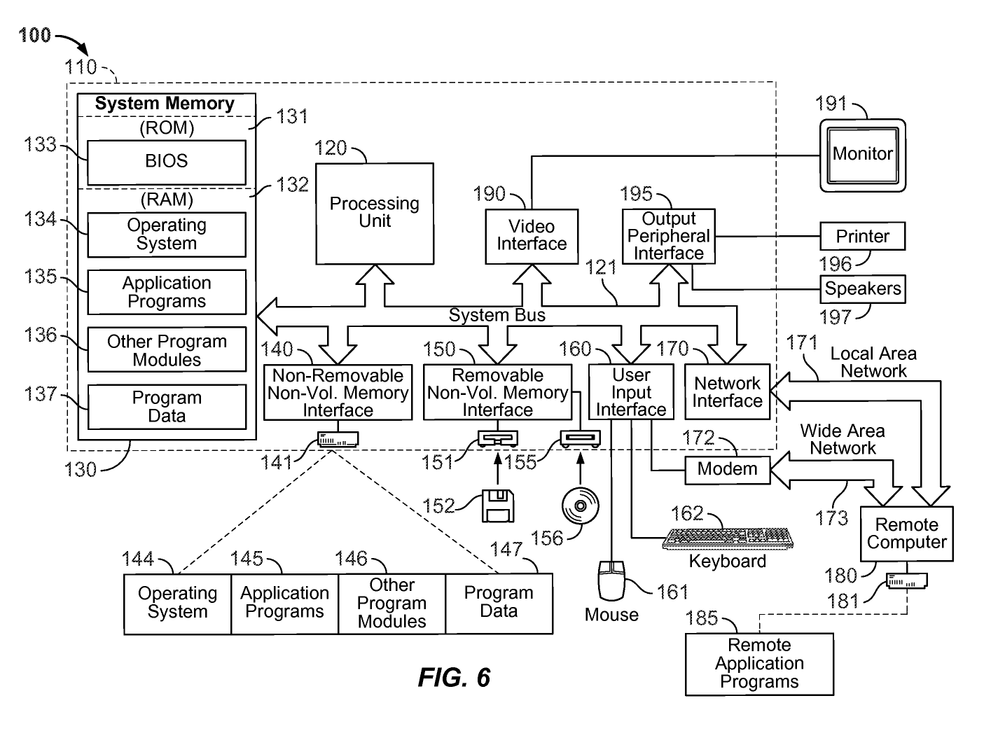

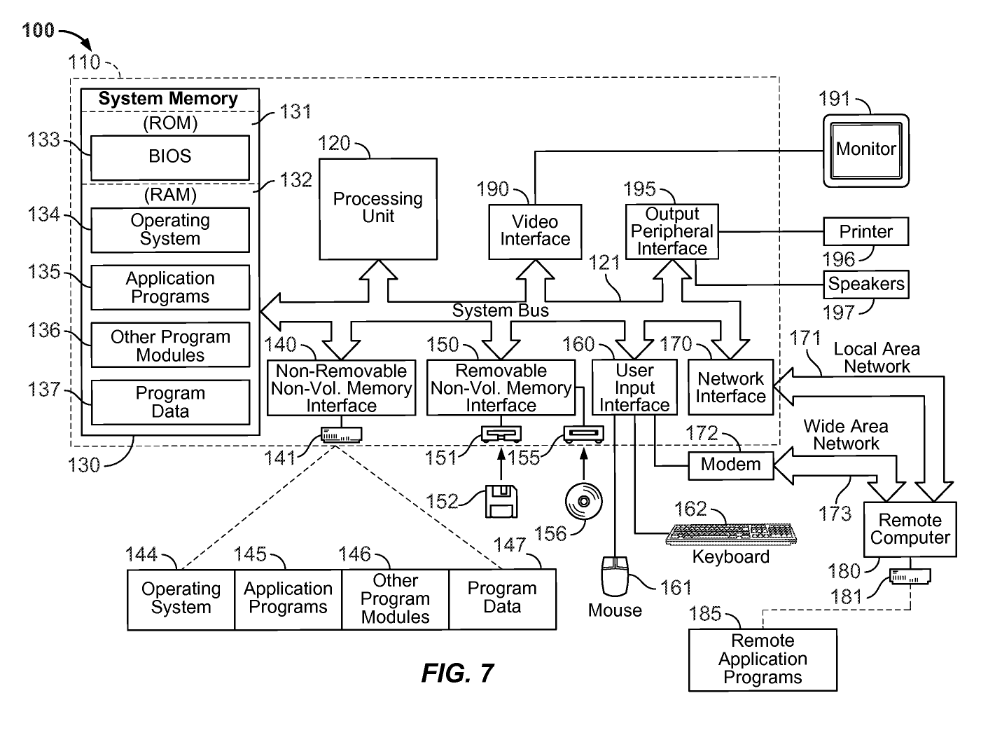

The client devices and servers discussed above may be implemented in a processing device such as that described with respect to FIG. 6. With reference to FIG. 6, an exemplary system for implementing the technology includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 10 illustrates operating system 134, application programs 135, other program modules 136, and program data 137.

The computer 110 may also include other removable/non-removable, volatile/nonvolatile computer storage media. By way of example only, FIG. 10 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 7, provide storage of computer readable instructions, data structures, program modules and other data for the computer 110. In FIG. 6, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 10. The logical connections depicted in FIG. 10 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 10 illustrates remote application programs 185 as residing on memory device 181. It will be appreciated that the network connections shown are exemplary and other means of establishing a communications link between the computers may be used.

The present technology provides users with method to ensure that items added to their block list are valid sources of email, making their block lists more efficient.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method for assisting email users, comprising:
receiving an action from a user which can be inferred to be a request to add an email source to a block list associated with the user;
determining whether blocking the source would be effective against exposing the user to additional email from the source; and
adding the source to the user block list if adding the source is determined to be effective.

2. The computer implemented method of claim 1 wherein the step of determining includes one of determining: whether or not an email passes a Sender ID authentication; whether or not an email passes DomainKeys Identified Mail authentication; whether or not an email is received from one or more Internet Protocol addresses; or whether or not the address is on a global blocklist.

3. The computer implemented method of claim 1 further including determining whether at least a second email is received from the source following said step of determining that the source is a valid source

4. The computer implemented method of claim 3 further including the step of determining whether to remove a source from a list after said step of adding if a message is not received from the source within a period of time.

5. The computer implemented method of claim 3 wherein the step of determining whether to remove a source includes determining, if emails are received during the first period of time, whether emails are received during a second period of time.

6. The method of claim 1 wherein the method is performed by a system having accounts for a plurality of users, and the method further includes the step of:
scanning user accounts for at least a subset of the plurality of users to determine whether information in at least a portion of the accounts of said plurality of users should cause a system-wide blocking of the source.

7. The method of claim 6 wherein the system maintains a global block list and the method includes the step of elevating a source present in a number of user accounts to the global block list.

8. The method of claim 7 further including the step of removing the source from the user accounts.

9. The method of claim 1 wherein the source is a user address.

10. The method of claim 1 wherein the source is a domain.

11. A computer implemented method maintaining user email block lists according to source, comprising;
presenting at least a portion of an email message to a user for review;
presenting an action selection interface to the user;
receiving an action from a user which can be inferred to be a request to add the source to a user block list or safelist;
determining whether blocking the source would be effective against exposing the user to additional email from the source; and
if the determination is that blocking the source would be effective, adding the email to a block list or safelist based on the user action.

12. The computer implemented method of claim 11 wherein the step of determining comprises one of determining: whether or not an email passes a Sender ID authentication; whether or not an email passes DomainKeys Identified Mail authentication; whether or not an email is received from one or more Internet Protocol addresses; or whether or not the address is on a global block list.

13. The computer implemented method of claim 11 wherein the source is subject to a probationary period prior to said step of adding.

14. The computer implemented method of claim 11 wherein following said step of adding, the method includes the step of determining whether additional emails are received from the source within a period of time, and removing the source from the block list if less than a threshold number of emails are received within the time period.

15. The computer implemented method of claim 11 wherein the method is performed by a system having accounts for a plurality of users, and the method further includes the step of:
scanning accounts of at least a subset of the plurality of users to determine whether a source is present in multiple accounts.

16. The computer implemented method of claim 15.further including the step of elevating the source to a global block list and the step of removing the source from user accounts.

17. The computer implemented method of claim 11 further including the step of automatically safe-listing the email address.

18. A method implemented by an email service provider having a plurality of users accessing email via the provider, the method for assisting email users, comprising:
receiving a command from a user which can be inferred to be a request to add the source to a block list associated with the user;
determining whether blocking the source would prevent additional email from the source from reaching the user based upon one or more criteria identifying the source as a valid source I;
adding the source to the user block list if the source is determined to be effective.

19. The computer implemented method of claim 18 wherein the step of determining comprises one of determining: whether or not an email passes a Sender ID authentication; whether or not an email passes DomainKeys Identified Mail authentication; whether or not an email is received from one or more Internet Protocol addresses; or whether or not the address is on a global block list.

20. The computer implemented method of claim 18 wherein the method further includes the step of maintaining a global block list and sources found in multiple user block lists are added to the global block list.
